(19) United States
(12) Patent Application Publication
(10) Pub. No.: US 2022/0301465 A1
(43) Pub. Date: Sep. 22, 2022

(54) Tabletop Advertising Stand with Integrated Magnifying View Port

(71) Applicant: Robert Scott Vance, Ashtabula, OH (US)

(72) Inventor: Robert Scott Vance, Ashtabula, OH (US)

(21) Appl. No.: 17/565,971

(22) Filed: Dec. 30, 2021

Related U.S. Application Data
(60) Provisional application No. 63/164,364, filed on Mar. 22, 2021.

(51) Int. Cl. G09F 23/06; G09F 15/00; G02B 25/00

(52) U.S. Cl. CPC G09F 23/06; G09F 15/0056; G09F 15/0012; G02B 25/002

(57) ABSTRACT

A tabletop advertisement stand is presented comprising a base horizontal to the tabletop, a vertical structure extending from the base, a display window integrated within the vertical structure that is configured to display media, and at least one magnifying view port integrated within the base. Wherein a user may position the base over a reading article to produce a magnified image through the view port.

### BACKGROUND

Individuals with farsightedness or poor vision often require the aid of reading glasses to clearly see and read small text. Such individuals must remember to bring their reading glasses with them when leaving the house if they wish to view articles with small text while out. If reading glasses are unavailable or were forgotten at home, a patron may not be able to read the content of menus, forms, and advertisements in the establishment they are visiting.

The present disclosure pertains to the field of tabletop advertisement stands, specifically those found in restaurants and taverns. Advertisement stands are commonly deployed on the tables of restaurants and taverns to display food and drink specials as well as advertisements and other promotional content. The problem to be solved by this disclosure is providing those individuals with poor eyesight a convenient magnifying means within the advertising stands commonly found on tabletops.

### SUMMARY

What is presented is a tabletop advertising stand comprising at least one magnifying view port that is added to or integrated within its base. This stand combines the functionality of a tabletop advertising stand commonly found on tables in many restaurants and bars with the image magnifying functionality of reading glasses for the convenience of customers with impaired vision. Any patron who forgot their reading glasses may simply pick this advertisement stand up from their table and use its magnifying view port to create an enlarged image of any text they wish to read.

The tabletop advertising stand presented herein comprises a base that lies horizontally on a tabletop and a vertical support structure which extends from the base. A two-sided display window is integrated within the vertical structure and is configured to display media such as advertisements, drink specials, and promotional content. The base, the vertical structure, and the display window may be created from a single length of formed material as shown in the preferred embodiment below or they may be separate components that are affixed together. The display window may be configured to display paper media, or may be an electronic display screen such as an LCD, CRT, or LED for displaying varying electronic media. The vertical structure also may be configured to receive a mobile device such as a tablet.

The magnifying view ports may be constructed with any type of magnifying material including glass lenses, films, filters, reflective mirrors, or any other material capable of producing an enlarged image of an object for ease of viewing. The magnifying view ports may be integrated within the base of the advertising stand during molding or attached to it by any joining method including welding, clamping, bolting, riveting, or the use of adhesives. It is preferred that the method of joining the magnifying view port to the base does not distort the image created by the magnifying view port. Magnifying view ports may be implemented on either or both sides of the base and may provide any degree of magnification as seen fit.

Preferably, the focal length of the magnifying view port and the distance of the magnifying view port from the tabletop are chosen such that the base need not be lifted from the tabletop to provide the minimum degree of magnification within a desired range of magnification. This enables a user to slide the advertising stand over the reading article to produce a magnified image without having to lift it. The bottom edges of the base may be rounded so that the advertising stand may be easily slid over the countertop. If necessary, the tabletop advertisement stand may be lifted off the tabletop to provide a larger degree of magnification.

In certain embodiments, LEDs may be incorporated within the base to illuminate a reading article beneath the advertising stand or to illuminate the display window. These LEDs may be toggled on by a user, or may automatically turn on when the advertising stand is pickup up from the table.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

For a more complete understanding and appreciation of this invention, and its many advantages, reference will be made to the following detailed description taken in conjunction with the accompanying drawings.

FIG. 1 is a perspective view of an embodiment of the tabletop advertising stand with integrated magnifying view port;

FIG. 2 is a side view of the advertising stand of FIG. 1;

FIG. 3 is a top view of the advertising stand of FIG. 1;

FIG. 4 shows a perspective view of the Tabletop Advertising Stand with Integrated Magnifying View Port holding an advertisement as it would be found in an industry setting;

FIG. 5 shows the advertising stand of FIG. 1 in an industry setting;

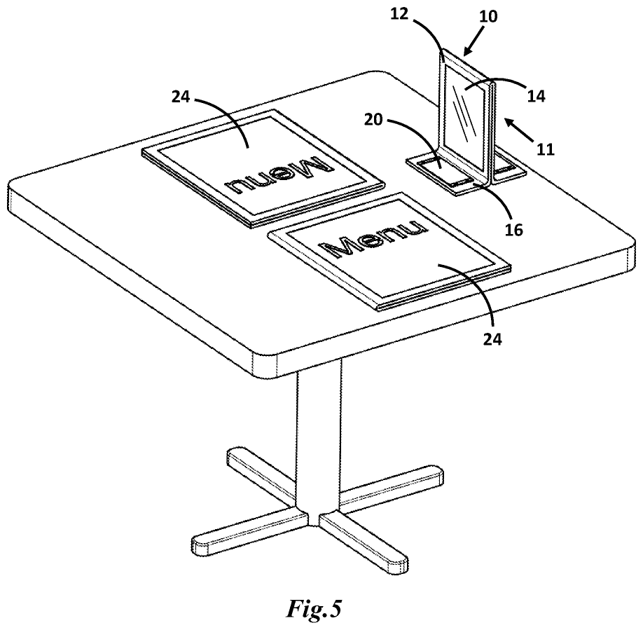

FIG. 6 shows the use of the magnifying view port to create an enlarged image of hard to read text.

FIG. 7 shows a perspective view of another embodiment of the Tabletop Advertising Stand with Integrated Magnifying View Port.

FIG. 8 shows a perspective view of the Tabletop Advertising Stand with Integrated Magnifying View Port of FIG. 7 displaying an advertisement as it would be found in an industry setting;

FIG. 9 shows a cut-section view of the Tabletop Advertising Stand with Integrated Magnifying View Port of FIG. 7.

FIG. 10 shows a perspective view of another embodiment of the Tabletop Advertising Stand with Integrated Magnifying View Port having LEDs within the base.

FIG. 11 shows a perspective view of another embodiment of the Tabletop Advertising Stand with Integrated Magnifying View Port having LEDs controlled by a momentary switch on the bottom face of the base.

### DETAILED DESCRIPTION

Referring now to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

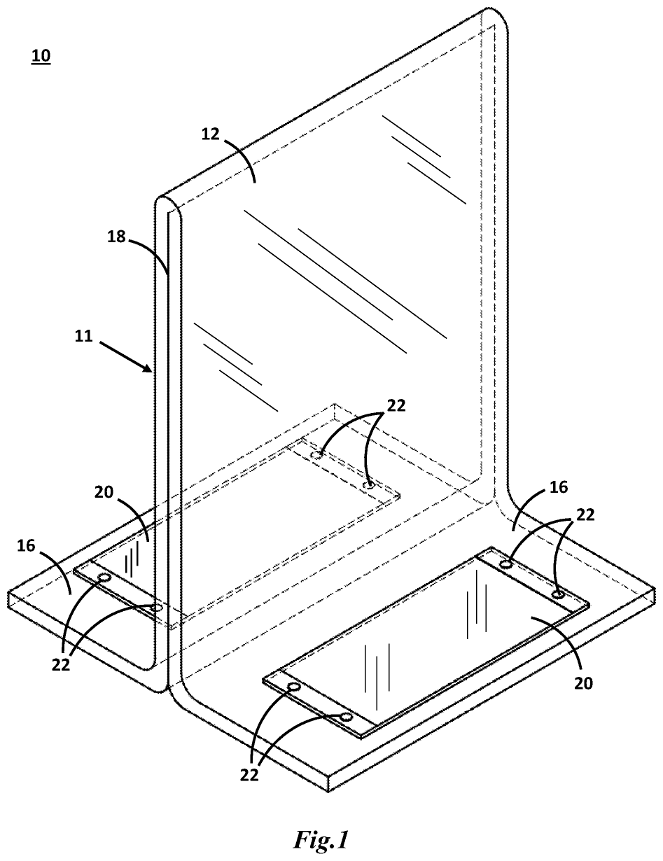

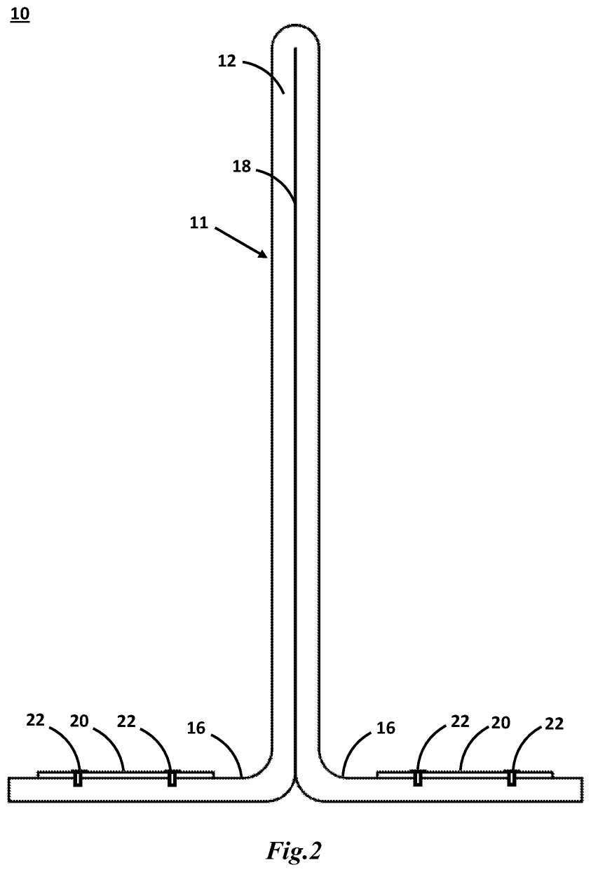

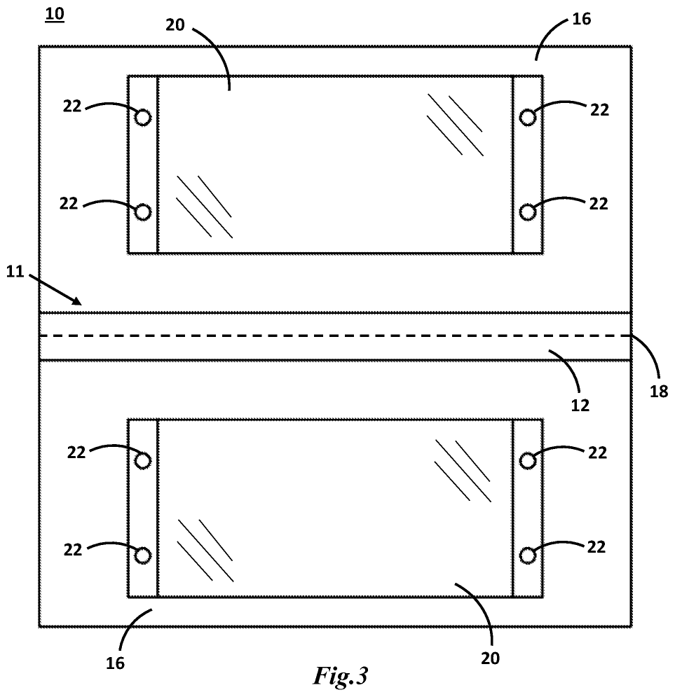

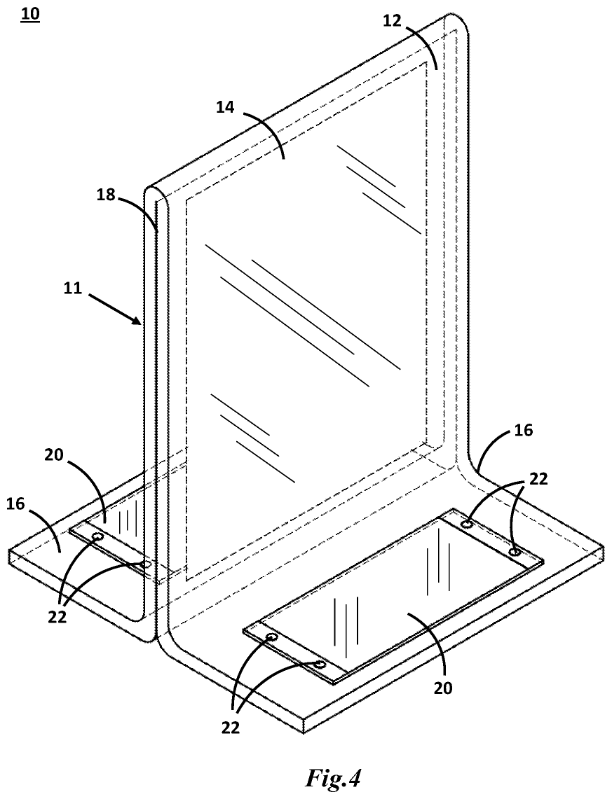

A tabletop advertising stand 10 is shown in its preferred embodiment in FIGS. 1-4. The tabletop advertising stand presented herein comprises a base 16 that lies horizontally on the tabletop and a vertical support structure 11 which extends from the base 16. The vertical structure 11 is configured to support a two-sided display window 12 that is configured to display media 14 such as advertisements, food menus, drink specials, etc.

As shown in FIGS. 1,2, and 4, the base 16 and display window 12 of the preferred embodiment are formed from one length of transparent rigid material such as acrylic, vinyl, polycarbonate, etc. The sheet is folded in half to form the two sides of the display window 12 and the two ends of the folded sheet are each bent 90 degrees away from each other to form the base 16 and support the display window 12 in a generally vertical manner. In this embodiment, the area of the rigid sheet that forms the display window 12 also forms the vertical structure 11 and as shown in FIGS. 1-4. The base 16, the vertical structure 11, and the display window 12 are formed from one sheet for cost effectiveness and ease of manufacturing, but the base 16, vertical structure 11, and the display window 12 may be several distinct components that are joined together.

A small gap 18 remains between the two sides of the display window 12, which is configured to receive media 14 which may be printed paper advertisements or other notices. The two sides of the base 16 may be easily spaced apart to expand the gap 18 for easy insertion of media 14 from the sides or bottom edge of the display window 12. When the sides of the base 16 are released, the gap 18 may close under the internal stress of the formed sheet and apply a light compressive force upon the media 14 to firmly secure the media 14 within the display window 12.

At least one magnifying view port 20 is integrated within the base 16. The magnifying view port 20 may be constructed with any type of magnifying material including glass lenses, films, filters, reflective mirrors, or any other material capable of producing an enlarged image of an object for ease of viewing. The magnifying view ports 20 may be integrated within the base 16 of the advertising stand 10 during molding or they may be attached to it by any joining method including welding, clamping, bolting, riveting, press-fit, or the use of adhesives. It is preferred that the method of joining the magnifying view port 20 to the base 16 does not distort the image created by the magnifying view port 20.

In the preferred embodiment, the magnifying view port 20 is a Fresnel lens that is made from a flexible plastic material. Fresnel lenses allow for a high degree of magnification while remaining relatively thin and low profile. Because the base 16 is made from a transparent plastic material, a magnifying view port 20 may attached to the top surface of each side of the base 16 via spot welds 22. The spot welds 22 create plastic roots that extend through the magnifying view port 20 and into the base 16 which secure the two components together.

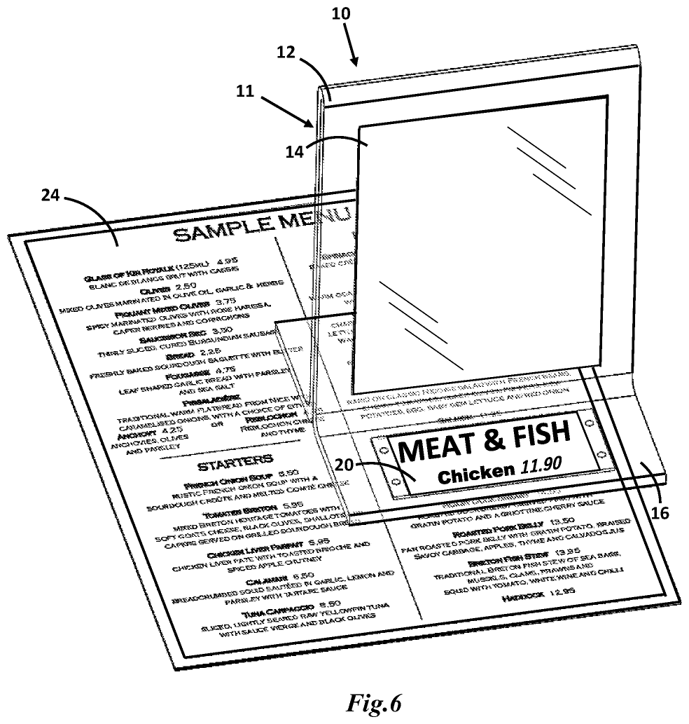

By integrating the magnifying view port 20 within the base, the view port 20 does not take up any advertising area from the display window 12 and the advertising stand 10 may be used in the upright position to magnify text from a reading article 24 as shown in FIG. 6. When used in this manner, the media 14 in the display window 12 is still visible to the user.

Preferably, the focal length of the magnifying view port 20 is chosen such that the base 16 need not be lifted from the tabletop to provide the minimum degree of magnification within a desired range of magnification. This enables a user to slide the advertising stand 10 over the reading article 24 without having to lift it off the reading article 24. If necessary, the tabletop advertisement stand 10 may be lifted off the tabletop to provide a larger degree of magnification as is understood in the art. Preferably, the magnifying view port 20 creates a magnification of at least 1.5× when the base is resting on the reading article 24. When the base is lifted off the reading article 24, it is preferred that the magnifying view port 20 creates an image with up to 5× magnification. The thickness of the base 16 and distance of the magnifying view port 20 from the tabletop must be taken into account when selecting the focal length of the magnifying view port 20.

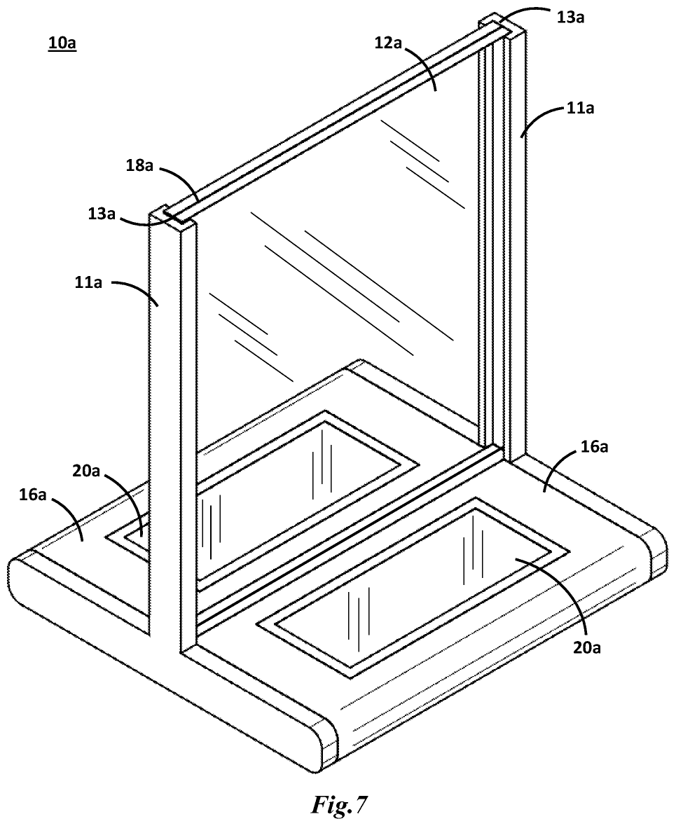

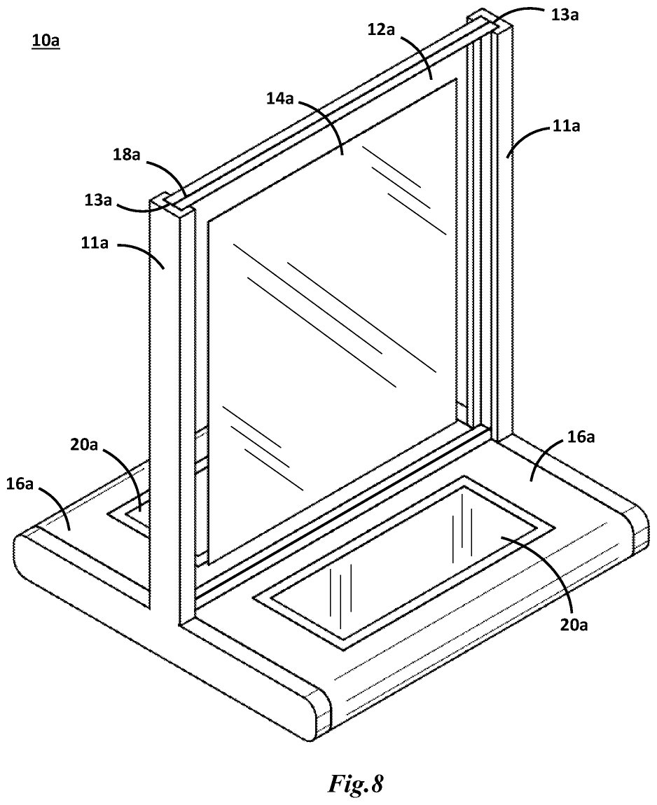

Referring now to FIGS. 7-9, an embodiment is shown wherein the display window 12a and the base 16a are formed separately. In this embodiment, the vertical structure 11a extends from the horizontal base 16a and is configured to receive 2 sheets of transparent material, such as glass or plastic, which form the viewing window 12a. The vertical structure comprised a groove 13a that is sized to receive the 2 sheets. A small gap 18a remains between the two sheets which allows media 14a such as an advertisement or drink menu to be inserted between them at the top edge of the viewing window 12a as shown in FIG. 8. Alternatively, the display window 12a may be an electronic display screen such as an LCD, CRT, or LED for displaying varying electronic media. The vertical structure 11a may also be configured to support a mobile device such as a tablet upon the base 16a.

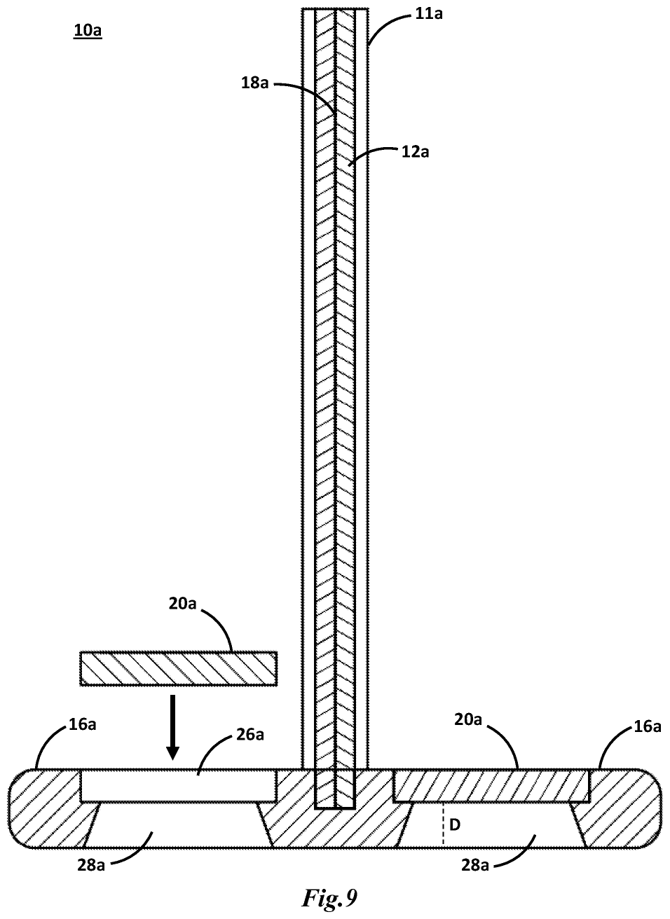

In this embodiment, the magnifying view ports 20a are press-fit within a recess 26a in the base 16a for a flush fit as shown in FIG. 9. If the base 16a is not made from a transparent material, a through hole 28a may be provided within the base 16a beneath recess 26a that provides a line of sight between the magnifying view ports 20a and a reading article 24a. As shown in FIG. 9, this through hole 28a may be tapered to ensure that no part of the base 16a is shown in the magnified image created by the magnifying view ports 20a.

Regardless of how the magnifying view port 20a is joined to the base 16a, the focal length of the magnifying view port 20a and the distance D between the magnifying view port 20a and bottom of the base 16a are chosen such that the base 16a need not be lifted from the tabletop to provide the minimum degree of magnification within a desired range of magnification. This enables a user to slide the advertising stand 10a over the reading article 24a without having to lift it off of the reading article 24a. This is beneficial for a user with an unsteady hand as the tabletop advertisement stand 10b remains supported on the reading article 24a while providing a sufficiently magnified image. If necessary, the tabletop advertisement stand 10a may be lifted off the tabletop to provide a larger degree of magnification. The bottom edges of the base 16a may be rounded or chamfered for easier sliding of the base 16a over a reading article 24a.

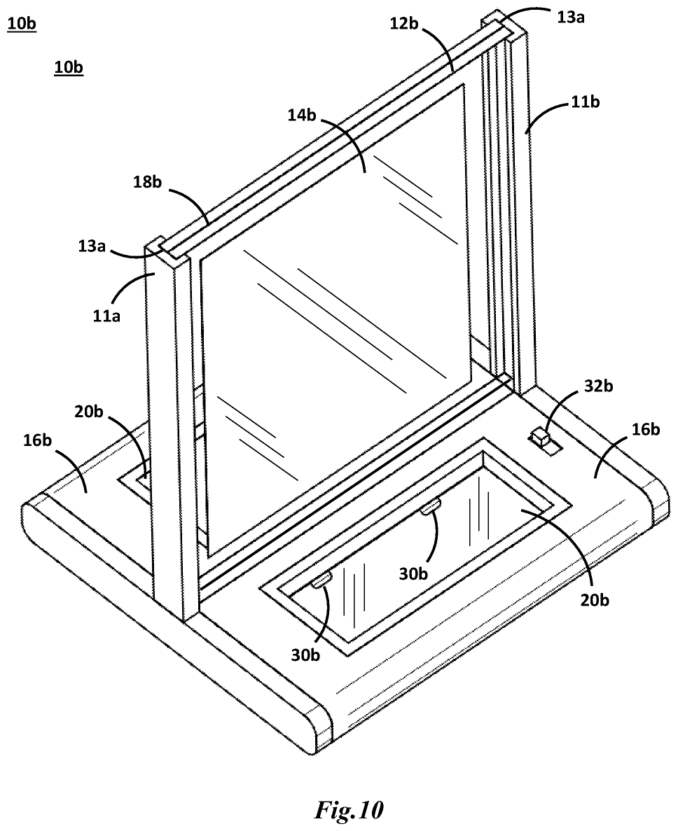

The embodiment shown in FIG. 10 comprises two light sources, such as LEDs 30b as shown in the figure within the base 16b that may be toggled on by a button or switch 32b which connects the LED 30b to a source of power within the base 16b such as a battery (not shown). The entire circuit controlling the LEDs 30b may be integral to the base 16b and may be easily accessible for changing of the battery. A user may place the tabletop advertisement stand 10b on top of a reading article 24b and toggle on the LEDs 30b to illuminate the text that they would like to create a magnified image of. The LEDs 30b may be positioned such that they also illuminate the media 14b in the display window 12b. A fiber optic fiber light source may also be used within the base 16b or vertical structure 11b to illuminate the media 14b within the display window 12b.

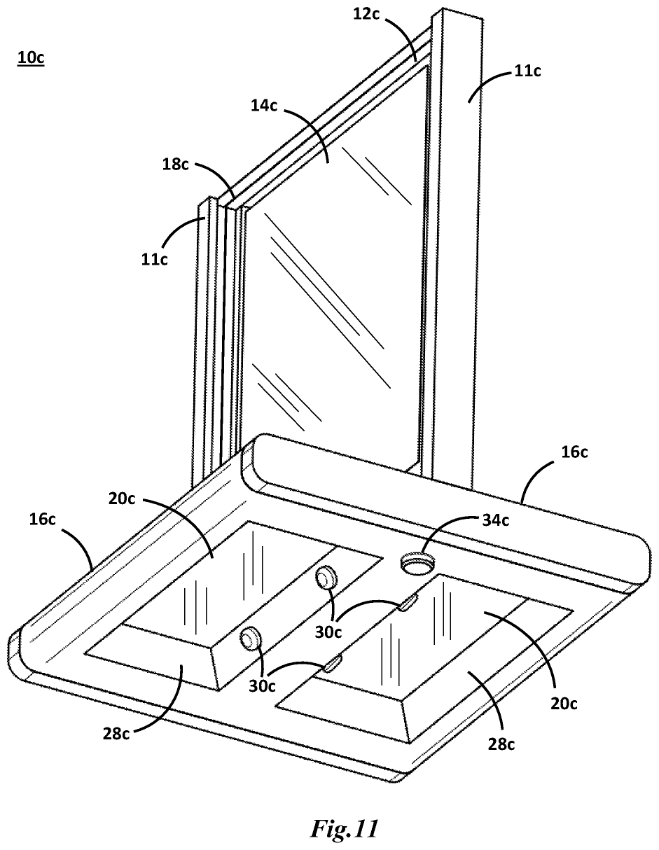

In another embodiment, the tabletop advertisement stand 10c may comprise a momentary switch 34c on the bottom face of the base 16c as shown in FIG. 11. This momentary switch 34c remains depressed within the base 16c under the weight of the tabletop advertising stand 10c when the stand 10c is on a tabletop. When the tabletop advertising stand 10c is picked up, the momentary switch 34c extends out of the base and connects the circuit between the LEDs 30c and a source of power within the base 16c (not shown) to illuminate a reading article 24c. When the stand 10c is placed back down, the momentary switch 34c is again depressed within the base 16c and the circuit is broken.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A tabletop advertisement stand, comprising:
a base horizontal to the tabletop;
a vertical structure extending from said base;
a display window integrated within said vertical structure that is configured to display media; and
at least one magnifying view port integrated within said base;
wherein a user may position said base over a reading article to produce a magnified image through said view port.

2. The tabletop advertisement stand of claim 1, further comprising said magnifying view port is any of a magnifying lens, magnifying glass, convex lens, plano-convex lens, magnifying film, Fresnel lens, magnifying plastic, or reflective mirror.

3. The tabletop advertisement stand of claim 1, wherein said magnifying view port is spaced apart from said tabletop based on its focal length to provide a desired degree of magnification.

4. The tabletop advertisement stand of claim 1, wherein the focal length of said magnifying view port is chosen such that said base may rest on said tabletop to provide at least a minimum magnification within a desired range.

5. The tabletop advertisement stand of claim 1, further comprising said display window is configured to display paper advertisement media.

6. The tabletop advertisement stand of claim 1, further comprising said display window is an electronic display screen such as an LCD, CRT, or LED for displaying electronic media.

7. The tabletop advertisement stand of claim 1, further comprising at least one light source integrated within said base to illuminate a reading article beneath the base.

8. The tabletop advertisement stand of claim 1, wherein said base, said vertical structure, and said display window are formed from one piece of material.

9. The tabletop advertisement stand of claim 1, wherein said base, said vertical structure, and said display window are formed from a transparent plastic sheet.

10. The tabletop advertisement stand of claim 1, further comprising at least one light source integrated within said base to illuminate the display window.

11. The tabletop advertisement stand of claim 1, further comprising at least one light source integrated within said base that turns on when the advertisement stand is lifted off of the tabletop.

12. The tabletop advertisement stand of claim 1, further comprising said magnifying view port is joined with said base by any joining method including welding, clamping, bolting, riveting, press-fit, or the use of adhesives.

13. The tabletop advertisement stand of claim 1, further comprising said vertical structure and said display window are formed from the same sheet.

14. The tabletop advertisement stand of claim 1, further comprising said magnifying view port is recessed within said base.

15. The tabletop advertisement stand of claim 1, further comprising said magnifying view port is molded within said base.

16. A tabletop advertisement stand, comprising:
a sheet of transparent rigid material folded in half to form a two-sided display window configured to display media and the ends of said sheet bent away from each other to form a base perpendicular to said display window;
at least one magnifying view port integrated within said base; and
wherein a user may position said base over a reading article to produce a magnified image through said view port.

17. The tabletop advertisement stand of claim 16, further comprising said magnifying view port is any of a magnifying lens, magnifying glass, convex lens, plano-convex lens, magnifying film, Fresnel lens, magnifying plastic, or reflective mirror.

18. The tabletop advertisement stand of claim 16, wherein said magnifying view port is spaced apart from said tabletop based on its focal length to provide a desired degree of magnification.

19. The tabletop advertisement stand of claim 16, wherein the focal length of said magnifying view port is chosen such that said base may rest on said tabletop to provide at least a minimum magnification within a desired range.

20. The tabletop advertisement stand of claim 16, further comprising said display window is configured to display paper advertisement media.

21. The tabletop advertisement stand of claim 1, further comprising at least one light source integrated within said base to illuminate a reading article beneath the base.

22. The tabletop advertisement stand of claim 1, further comprising at least one light source integrated within said base to illuminate the display window.

23. The tabletop advertisement stand of claim 1, further comprising at least one light source integrated within said base that turns on when the advertisement stand is lifted off of the tabletop.

24. The tabletop advertisement stand of claim 1, further comprising said magnifying view port is joined with said base by any joining method including welding, clamping, bolting, riveting, press-fit, or the use of adhesives.

25. The tabletop advertisement stand of claim 1, further comprising said magnifying view port is recessed within said base.

26. The tabletop advertisement stand of claim 1, further comprising said magnifying view port is molded within said base.
